(19) United States
(12) Patent Application Publication
(10) Pub. No.: US 2006/0010916 A1
(43) Pub. Date: Jan. 19, 2006

(54) Method and machine for obtaining asymetric convex glass sheets

(75) Inventors: Jacques Leclercq, Roisel (FR); Jean-Luc Riedinger, Villers Sur Coudun (FR); Gilles Garnier, Dompierre (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: SAINT-GOBAIN GLASS FRANCE, COURBEVOIE (FR)

(21) Appl. No.: 10/527,631

(22) PCT Filed: Oct. 8, 2003
(86) PCT No.: PCT/FR03/02959

§ 371 Date: Mar. 14, 2005

(30) Foreign Application Priority Data
Oct. 10, 2002 (FR) 02/12577

(51) Int. Cl. C03B 40/02; C03B 23/02

(52) U.S. Cl. 65/25.4; 65/182.2; 65/107; 65/273; 65/287

(57) ABSTRACT

Glass sheets that have been raised beforehand to their softening point are moved along, progressively giving them a desired bent shape. Between an initial bending phase in which the sheets begin to adopt their shape and a final phase of bending, continuous blowing of air is performed, at a point along the line along which the sheets move, onto at least one face of the glass sheets, under conditions capable of asymmetrically influencing a final concavity of the bent glass sheets by comparison with a concavity that the final bending would have given without the blowing. The bending machine includes at least one nozzle blowing air continuously and arranged at a point on the line along which the sheets move after the sheets have begun to take shape and before the final phase of bending. The at least one nozzle is arranged to blow air asymmetrically onto the sheets.

The present invention relates to techniques for obtaining bent and possibly thermally toughened glass sheets, whether the sheets be bent to cylindrical shapes or to complex non-cylindrical shapes.

More specifically, the invention relates to those of these techniques in which the glass sheets are made to move along at least one shaping bed consisting of shaping rods, for example rotary elements arranged in a path with a profile that is curved in the direction of travel of the glass sheets.

The invention applies for example to the production of automotive glazing, for example of the side window type.

Such bending techniques are currently employed at very high production rates due, in particular, to the possibility of moving the glass sheets along with a spacing of just a few centimeters between them. They allow very good repeatability of the curvature and of the optical quality of the end glazing.

However, the shapes of these bent sheets are becoming increasingly complex.

Admittedly, it is possible to alter the shape of the shaping rods used to form the shaping bed for bending. However, that entails constructing for each new series of bent glass sheets, a new shaping bed with lengthy and precise mounting of the new shaping rods, even though the modifications to be made to a curvature are of the order of few tenths of a millimeter to a few millimeters.

In order to solve this difficulty, the present invention proposes an improvement to the current bending methods and machines, said improvement consisting in continuous and asymmetric blowing of air over the glass sheets under conditions able to influence the final concavity of the sheet by comparison with conventional bending without this asymmetric blowing.

The subject of the present invention is therefore first of all a method for producing bent glass sheets whereby glass sheets which have been raised beforehand to their softening point are moved along, progressively giving them the desired bent shape, characterized in that, between the initial bending phase in which the sheet begins to adopt its shape and the final phase of said bending, continuous blowing of air is performed, at a point along the line along which the sheets move, onto at least one face of the glass sheets, under conditions capable of asymmetrically influencing the final concavity of the bent glass sheets by comparison with the concavity that the final bending would have given without said blowing.

According to a first embodiment, the blowing of air onto just one face of the glass sheets is performed in at least one transverse region of these sheets with respect to the axis along which they move. It is thus possible to perform the blowing on just one side with respect to the axis along which they move, or alternatively, to perform the blowing across the entire transverse region of the glass sheets with respect to the axis along which they move.

According to a second embodiment, the blowing of air is performed on both faces of the glass sheets, said blowing not being performed across the entire transverse region of the glass sheets on at least one of the faces. It is thus possible to blow air on each side of the glass sheets as they move along and on just one side with respect to the axis along which they move.

According to the method of the invention, the air blown may be cold enough or hot enough with respect to the bending temperature for the blowing to have an influence on the final bending.

Air may be blown at a temperature other than the temperature at which bending is carried out so as to give greater concavity on one side of the glass sheet. If the blowing has a tendency to lower the temperature of the face of the glass sheet receiving said blowing, the concavity will be increased on the other side of the sheet, that is to say on the side that did not receive said blowing, by comparison with the concavity obtained in the absence of said blowing. If the blowing tends to increase the temperature of the face of the glass sheet receiving said blowing then the concavity will be locally increased on the side that received said blowing, by comparison with the concavity obtained in the absence of said blowing. According to the invention, air is blown at a temperature other than the temperature at which bending is carried out, the blowing producing an increase in concavity on the same side as the face receiving it if the blowing causes heating, the blowing producing a reduction in concavity on the same side of the face receiving it if the blowing produces cooling.

Since, in general, before receiving the blowing, the two faces of the sheet are at more or less the same temperature, the concavity is generally increased by blowing on the side of the face of the glass that is the hottest.

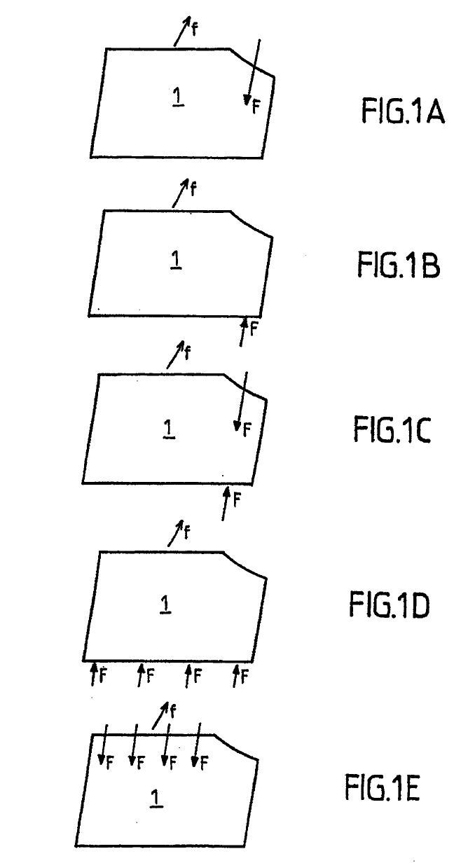

The concavity is increased in all directions on the side of the face of the glass that has its concavity increased, that is to say both in the direction of travel and in the plane perpendicular to the direction of travel. This effect can be observed at the points that received the blowing. Just part of the sheet may therefore be affected by this effect (the case of FIGS. 1A, 1B, 1C).

Said blowing is advantageously performed by directing air onto the glass sheets at a pressure ranging from 4.90×10³ to 9.81×10³ Pa (500 to 1000 mm water column).

The method according to the invention leads in particular to bent glass sheets exhibiting variations in dimension ranging from 2/10 mm to 2 mm with respect to bending without blowing.

According to other features of the method according to the invention:
the bending is performed with a radius of curvature of a line parallel to the direction of travel ranging from 1 meter to infinity and a radius of curvature of a line perpendicular to the direction of travel ranging from 5 meters to infinity;
glass sheets which have taken shape at a temperature of 600 to 700° C. are moved along.

In one preferred particular embodiment, sheets of glass are moved along in a planar trajectory through a reheat furnace in order to bring them to the softening point, then in a trajectory with a curved profile tangential to the aforementioned planar trajectory over a shaping bed consisting of shaping rods, the blowing being performed at a point situated along the curved-profile trajectory after the sheets have begun to take shape.

It is also possible to give the glass sheets their shape by performing sag bending, then to continue bending in a trajectory with a curved profile over a shaping bed consisting of shaping rods, blowing being performed along said curved-profile trajectory.

It is also possible to subject the glass sheets to toughening downstream of the blowing and before the end of the bending. In particular, the toughening may be performed by directing air at a pressure ranging from 2.94×10⁴ Pa to 3.43×10⁴ Pa (3000 to 3500 mm water column).

The present invention also relates to bent glass sheets obtained or likely to be obtained by the method as defined hereinabove; and to bent glass sheets exhibiting asymmetry likely to be detected by polariscopy or by measuring stress by techniques employing an epibiascope (possibly also a stratorefractometer or a biasgraph). What happens is that the blowing performed continuously and asymmetrically onto the sheets as they move along may give rise to traces parallel to the direction of travel, more particularly in the cases illustrated in FIGS. 1a, 1b and 1c. Thus, the invention relates in particular to a bent glass sheet exhibiting at least one straight line that can be detected by polariscopy or using a biasgraph, more or less parallel to one of the edges of the sheet and closer to this edge than to the other edge more or less parallel to it (because of the asymmetry with respect to the axis along which they move in the case of FIGS. 1a, 1b, 1c).

The present invention relates finally to a machine for bending glass sheets comprising means for moving along glass sheets which have been raised beforehand to their softening point, giving them the desired bent shape, characterized in that this machine further comprises at least one nozzle for blowing air continuously, this nozzle being arranged at a point on the line along which the sheets move after the sheets have begun to take shape and before the final phase of said bending, the nozzle or nozzles being arranged in such a way as to blow air asymmetrically onto said sheets, and set up so that said air blowing influences the final concavity of the bent glass sheets by comparison with the concavity that the final bending would have given without said blowing.

The bending machine according to the invention advantageously comprises a shaping bed consisting of shaping rods in a path with a curved profile, the asymmetric blowing nozzle or nozzles being aimed between two adjacent shaping rods of the shaping bed.

It may also further comprise blowing plenums for toughening, downstream of the asymmetric blowing nozzle or nozzles, said blowing plenums for toughening each comprising nozzles arranged in arrays and aimed between two adjacent shaping rods of the shaping bed.

In order to better illustrate the method and machine according to the present invention, several particular embodiments thereof will now be described by way of nonlimiting indication with reference to the attached drawing in which:

FIGS. 1A to 1E are diagrams illustrating various alternative forms of asymmetric blowing according to the present invention;

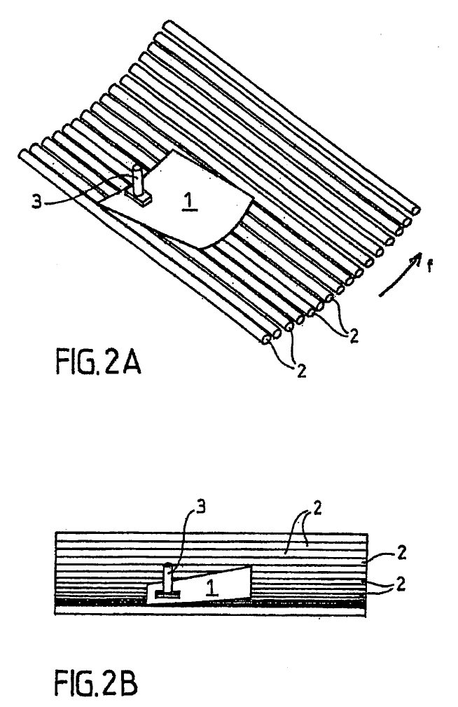

FIGS. 2A and 2B are schematic depictions in perspective and from above respectively, of a glass sheet moving along over the shaping rods of a shaping bed, at the instant when said sheet passes under an asymmetric blowing nozzle according to the alternative form of FIG. 1A;

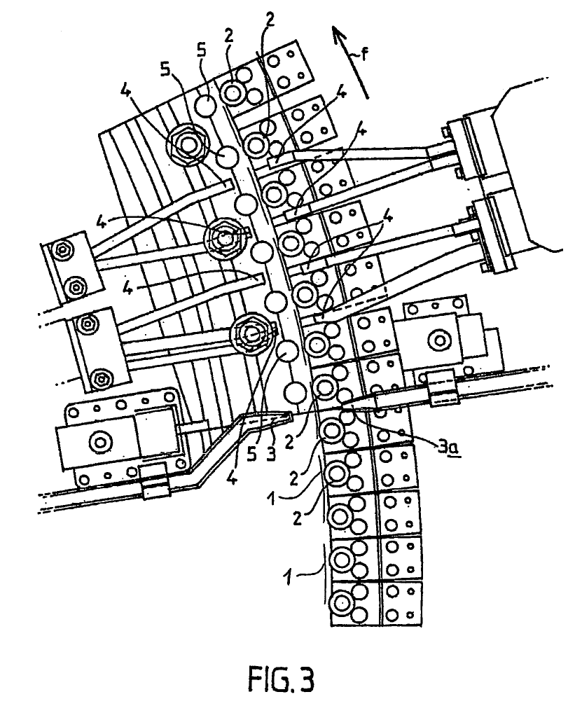

FIG. 3 is a schematic profile view of a machine for bending glass sheets, showing the curved-profile trajectory of these sheets;

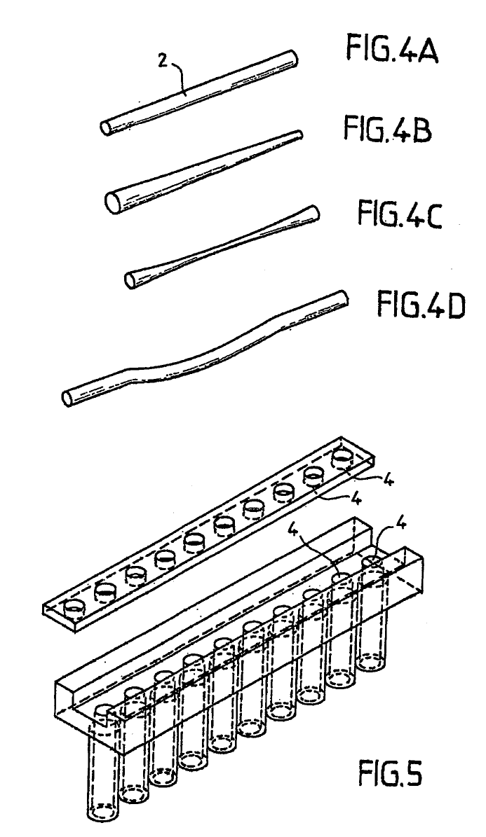

FIGS. 4A to 4D each show, schematically and in perspective, one alternative form of a shaping rod; and

FIG. 5 shows, schematically and in perspective, two opposing arrays of toughening nozzles belonging to the bending machine.

Each of FIGS. 1A to 1E schematically depicts a glass sheet 1 cut with a view to producing a motor vehicle side window, and the arrow f has been used to symbolize the axis along which it moves along the bending line.

According to the invention, hot or cold air is blown asymmetrically (as symbolized by the arrows F) over the sheet 1 as it moves along before final bending, for example from above the sheet 1 and on one side (FIG. 1A), from below the sheet 1 and on one side (FIG. 1B), simultaneously from above and below the sheet 1 and on the same side (FIG. 1C), from below the sheet 1 and over the entire transverse region thereof (FIG. 1D), or alternatively from above the sheet 1 and over the entire transverse region thereof (FIG. 1E).

When air is blown at a temperature other than the temperature at which bending is carried out, the concavity is modified as explained above, not only as far as the concavity in the direction of travel is concerned, but also as regards the concavity in the plane perpendicular to the direction of travel.

In the case of FIGS. 1A to 1C, the asymmetric blowing will make it possible to modify the bending on one side of the window, such a method advantageously being applied to the manufacture of a car front side window which has greater curvature at the rear than at the front.

It should, however, be emphasized that the asymmetric blowing does not preclude the simultaneous use of other means in order to arrive at the desired final shape, such as the shape of the shaping rods as will be described later on.

The asymmetric blowing according to the invention is then seen as an additional way to set the desired final shape of the bent sheet.

In practice, preference is given to the alternative form of FIG. 1A where the air blown is cold (with respect to the bending temperature).

In the case of the alternative forms of FIGS. 1D and 1E, bending is influenced over the entire transverse region of the moving sheet, and this is useful particularly when manufacturing series of bent sheets of different shapes. As mentioned hereinabove, the asymmetric blowing is a simple adjusting means avoiding having to rebuild the bending line.

FIGS. 2A and 2B show a sheet 1 moving over cylindrical shaping rods 2, with the location of an asymmetric blowing nozzle 3 according to the invention.

FIG. 3 depicts a bending machine comprising, in a known way, a conveyor forming a shaping bed and consisting of shaping rods 2 which are rotary cylindrical elements arranged in a path with a curved profile, in practice a circular profile with a concavity facing upward.

The conveyor is extended in fact without breaking the route taken by the glass sheets heated to the softening point in a reheat furnace. In other words, the shaping bed is tangential to the planar trajectory with which the glass sheets arrive at this bed.

In the latter, the trajectory followed by the glass sheets is cylindrical, the generatrices of the cylinder being horizontal and perpendicular to the direction of conveying, in the flat state, of the glass. The radius of the cylinder on which the trajectory of the glass sheet is based corresponds to the radius of curvature conferred upon the glass sheet in the direction parallel to the direction of travel.

With rotary elements consisting of straight rods, a right cylinder is obtained (FIG. 4A). Other shapes exhibiting symmetry of revolution are obtained by substituting for the straight rods conical rods (FIG. 4B), toric rods (FIG. 4C) or rods in the shape of handlebars (FIG. 4D). These other shapes entail the use of upper backing rolls.

According to the invention, air is blown onto one side of the sheet (cf. FIGS. 2A and 2B) by the upper nozzle 3 which directs air at the chosen temperature between two shaping rods 2. FIG. 3 also depicts a lower blowing nozzle 3a which could be omitted and which could be used in place of the nozzle 3 for the embodiment according to FIG. 1B or at the same time as the latter for the embodiment of FIG. 1C.

The asymmetric blowing nozzles 3 and 3a are arranged upstream of a terminal bending zone in which a thermal toughening operation is performed in a known way, for which nozzles 4 for blowing cold air are arranged in four lower arrays and four upper arrays opposite, over the entire width of the bending machine.

It is possible, as the case may be, to employ just one of the two asymmetric blowing nozzles (3 or 3a). It is also possible to employ the two nozzles 3 and 3a simultaneously (as is the case in FIG. 1C).

Upper retaining means of the backing roll type 5 are arranged in the bending/toughening zone downstream of the nozzles 3. The lower nozzles 4 are aimed between two shaping rods 2, and the upper nozzles 4 are aimed between two backing rolls 5.

It is pointed out that the asymmetric nozzles 3, 3a are placed just before the first upper backing roll 5.

The glass sheets are made to move along at a high speed at least equal to 10 cm/s and preferably of the order of 15 to 18 cm/s and they then acquire the profile corresponding to the shaping bed under the combined effect of gravity and of the speed upstream of the nozzles 3a, with, in addition, the pressing of the backing rolls 5 in the bending/toughening zone.

For glass sheets 3 mm thick, the shaping rods are typically spaced 50 to 100 mm apart.

1-24. (canceled)

25. A method for producing bent glass sheets comprising:
making glass sheets run over at least one shaping bed, for bending them, along a path with a curved profile in a run direction of the glass sheets, the glass sheets having been brought beforehand to their softening temperature, progressively giving them a desired bent shape;
wherein, between an initial bending phase in which the glass sheets begin to adopt their shape and a final phase of bending, continuous blowing of air is performed, at a point on the path along which the glass sheets run, onto at least one face of the running glass sheets, under conditions capable of asymmetrically influencing a final concavity of the bent glass sheets by comparison with a concavity that the final bending would have given without the blowing.

26. The method as claimed in claim 25, wherein the blowing of air onto one face of the glass sheets is performed in at least one transverse region of the glass sheets with respect to an axis along which they run.

27. The method as claimed in claim 26, wherein the blowing of air is performed on just one side with respect to the axis along which the glass sheets run.

28. The method as claimed in claim 26, wherein the blowing of air is performed across an entire transverse region of the glass sheets with respect to the axis along which the glass sheets run.

29. The method as claimed in claim 25, wherein the blowing of air is performed onto both faces of the glass sheets, the blowing not being performed across an entire transverse region of the glass sheets on at least one of the faces.

30. The method as claimed in claim 29, wherein the blowing of air is performed on each side of the glass sheets as the glass sheets run along and on just one side with respect to an axis along which the glass sheets run.

31. The method as claimed in claim 25, wherein the air blown is cold enough with respect to a bending temperature for the blowing to have an influence on the final bending.

32. The method as claimed in one of claim 25, wherein the air blown is hot enough with respect to a bending temperature for the blowing to have an influence on the final bending.

33. The method as claimed in one of claim 25, wherein air is blown at a temperature other than a temperature at which bending is carried out, the blowing producing an increase in concavity on the same side as the face receiving the blowing if the blowing causes heating, the blowing producing a reduction in concavity on the same side of the face receiving the blowing if the blowing produces cooling.

34. The method as claimed in claim 25, wherein air is blown at a temperature other than a temperature at which bending is carried out so as to give further concavity in a plane perpendicular to the run direction.

35. The method as claimed in one of claim 25, wherein the blowing is performed by directing air onto the glass sheets at a pressure ranging from 4.90×10³ to 9.81×10³ Pa (500 to 1000 mm water column).

36. The method as claimed in claim 25, leading to bent glass sheets exhibiting variations in dimension ranging from 2/10 mm to 2 mm with respect to bending without blowing.

37. The method as claimed in claim 25, wherein the bending is performed with a radius of curvature of a line parallel to the run direction ranging from 1 meter to infinity and a radius of curvature of a line perpendicular to the run direction ranging from 5 meters to infinity.

38. The method as claimed in claim 25, wherein glass sheets that have taken a shape at a temperature of 600 to 700° C. are moved along.

39. The method as claimed in claim 25, wherein the glass sheets are made to run in a planar trajectory through a reheat furnace to bring them to the softening point, then in a trajectory with a curved profile tangential to the planar trajectory over a shaping bed of shaping rods, and the blowing is performed at a point situated along the curved-profile trajectory after the glass sheets have begun to take shape.

40. The method as claimed in claim 25, wherein the shape is given to the glass sheets by performing sag bending, then bending is continued in a trajectory with a curved profile over a shaping bed of shaping rods, blowing being performed along the curved-profile trajectory.

41. The method as claimed in claim 25, wherein the glass sheets are subjected to toughening downstream of the blowing and before an end of the bending.

42. The method as claimed in claim 41, wherein the toughening is performed by directing air at a pressure ranging from 2.94×10⁴ Pa to 3.43×10⁴ Pa (3000 to 3500 mm water column).

43. Bent glass sheets obtained by the method as defined in claim 25.

44. Bent glass sheets exhibiting asymmetry likely to be detected by polariscopy or by measuring stress by using techniques employing an epibiascope.

45. The glass sheets as claimed in claim 44 exhibiting at least one straight line that can be detected by polariscopy or using a biasgraph, more or less parallel to a first of edges of the glass sheets and closer to the first edge than to a second other edge more or less parallel to it.

46. A machine for bending glass sheets comprising:
means for moving along glass sheets that have been raised beforehand to their softening point, giving them a desired bent shape;
at least one nozzle for blowing air continuously, the at least one nozzle arranged at a point on a line along which the glass sheets run after the glass sheets have began to take shape and before a final phase of the bending, the at least one nozzle being arranged in such a way as to blow air asymmetrically onto the glass sheets, and set up so that the air blowing influences a final concavity of the bent glass sheets by comparison with a concavity that the final bending would have given without the blowing.

47. The bending machine as claimed in the claim 46, further comprising a shaping bed including shaping rods in a path with a curved profile, the asymmetric blowing of the at least one nozzle being aimed between two adjacent shaping rods of the shaping bed.

48. The bending machine as claimed in claim 47, further comprising blowing plenums for toughening, downstream of the asymmetric blowing of the at least one nozzle, the blowing plenums for toughening and each comprising nozzles arranged in arrays and aimed between two adjacent shaping rods of the shaping bed.
